(19) United States
(12) Patent Application Publication
(10) Pub. No.: US 2025/0249849 A1
(43) Pub. Date: Aug. 7, 2025

(54) PROTECTOR AND WIRE HARNESS

(71) Applicant: YAZAKI CORPORATION, Tokyo (JP)

(72) Inventor: Shinichi Ikeda, Makinohara-shi (JP)

(21) Appl. No.: 19/035,843

(22) Filed: Jan. 24, 2025

(30) Foreign Application Priority Data
Feb. 2, 2024 (JP) 2024-014578

(51) Int. Cl. B60R 16/02; H02G 3/30

(52) U.S. Cl. CPC B60R 16/0215; H02G 3/30

(57) ABSTRACT

A protector includes a base having a base-side bottom wall that supports a plurality of electric wires extending along an axial direction; and a cover having a cover-side bottom wall facing the base-side bottom wall, the plurality of electric wires being sandwiched between the cover-side bottom wall and the base-side bottom wall in a state where the cover-side bottom wall is elastically deformed along outer shapes of the plurality of electric wires.

### CROSS-REFERENCE TO RELATED APPLICATION(S)

The present application claims priority to and incorporates by reference the entire contents of Japanese Patent Application No. 2024-014578 filed in Japan on Feb. 2, 2024.

### BACKGROUND OF THE INVENTION

### 1. Field of the Invention

The present invention relates to a protector and a wire harness.

### 2. Description of the Related Art

As a technique related to a protector of a wire harness of the prior art, for example, Japanese Patent Application Laid-open No. 2021-114401 A discloses a protector including a base having a base-side bottom wall that supports a plurality of electric wires extending along an axial direction, and a cover having a cover-side bottom wall facing the base-side bottom wall and accommodating the plurality of electric wires between the cover-side bottom wall and the base-side bottom wall.

The protector described in Japanese Patent Application Laid-open No. 2021-114401 A described above has, for example, room for further improvement in terms of improving the holding force of the plurality of electric wires.

### SUMMARY OF THE INVENTION

The present invention has been made in view of the above circumstances, and an object thereof is to provide a protector and a wire harness capable of improving the holding force of a plurality of electric wires.

In order to achieve the above mentioned object, a protector according to one aspect of the present invention includes a base having a base-side bottom wall that supports a plurality of electric wires extending along an axial direction; and a cover having a cover-side bottom wall facing the base-side bottom wall, the plurality of electric wires being sandwiched between the cover-side bottom wall and the base-side bottom wall in a state where the cover-side bottom wall is elastically deformed along outer shapes of the plurality of electric wires.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is an exemplary perspective view of a wire harness to which a protector according to an embodiment is applied;

FIG. 2 is an exemplary exploded perspective view of the protector according to the embodiment;

FIG. 3 is an exemplary exploded perspective view of the protector according to the embodiment as viewed from an angle different from that in FIG. 2;

FIG. 4 is an exemplary perspective view of the protector according to the embodiment in a state in which a cover is removed; and

FIG. 5 is an exemplary perspective view of the protector according to the embodiment in a state in which a cover is attached.

### DETAILED DESCRIPTION OF THE PREFERRED EMBODIMENTS

Hereinafter, an embodiment according to the present invention will be described in detail with reference to the drawings. Note that the present invention is not to be limited by the following embodiments. In addition, constituent elements in the following embodiments include those that can be easily replaced by those skilled in the art or those that are substantially the same. Note that in the present specification, ordinal numbers are used only to distinguish components, members, sites, positions, directions, and the like, and do not indicate order or priority.

### Embodiment

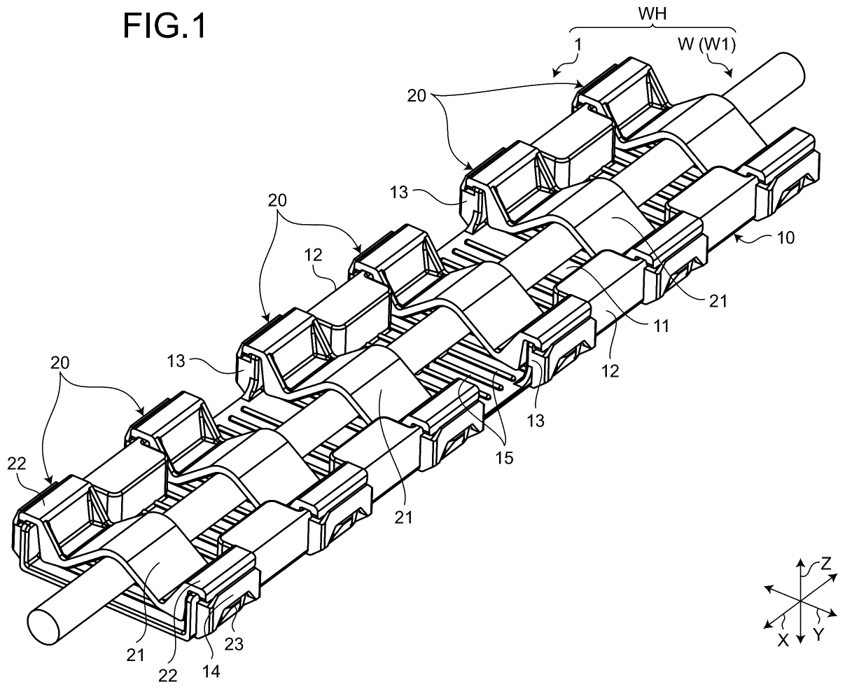

FIG. 1 is a perspective view of a wire harness WH to which a protector 1 according to an embodiment is applied. The protector 1 of the present embodiment illustrated in FIG. 1 is incorporated in the wire harness WH routed in a vehicle such as an automobile. Here, for example, the wire harness WH is configured such that a plurality of electric wires W used for power supply and signal communication are bundled to form a collective component for connection between devices mounted on a vehicle, and the plurality of electric wires W are connected to each device by a connector or the like. The wire harness WH of the present embodiment includes a plurality of electric wires W having conductivity and a protector 1 that holds the plurality of electric wires W. Note that the wire harness WH may further include various components such as a grommet, an electrical connection box, and a fixing tool.

Note that in the following description, among a first direction, a second direction, and a third direction intersecting each other, the first direction is referred to as an “axial direction X”, the second direction is referred to as a “width direction Y”, and the third direction is referred to as a “height direction Z”. Here, the axial direction X, the width direction Y, and the height direction Z are substantially orthogonal to each other. The axial direction X typically lies along an extending direction of the plurality of electric wires W, the insertion direction of the plurality of electric wires W with respect to the protector 1, the longitudinal direction (extending direction) of the protector 1, and the like. The width direction Y typically lies along the width direction or the like of the protector 1. The height direction Z typically lies along a height direction (up-down direction) of the protector 1, a stacking direction of a base 10 and a cover 20, which will be described later, of the protector 1, and the like. In addition, each direction used in the following description will be described as a direction in a state where the protector 1 is assembled to the vehicle unless otherwise specified.

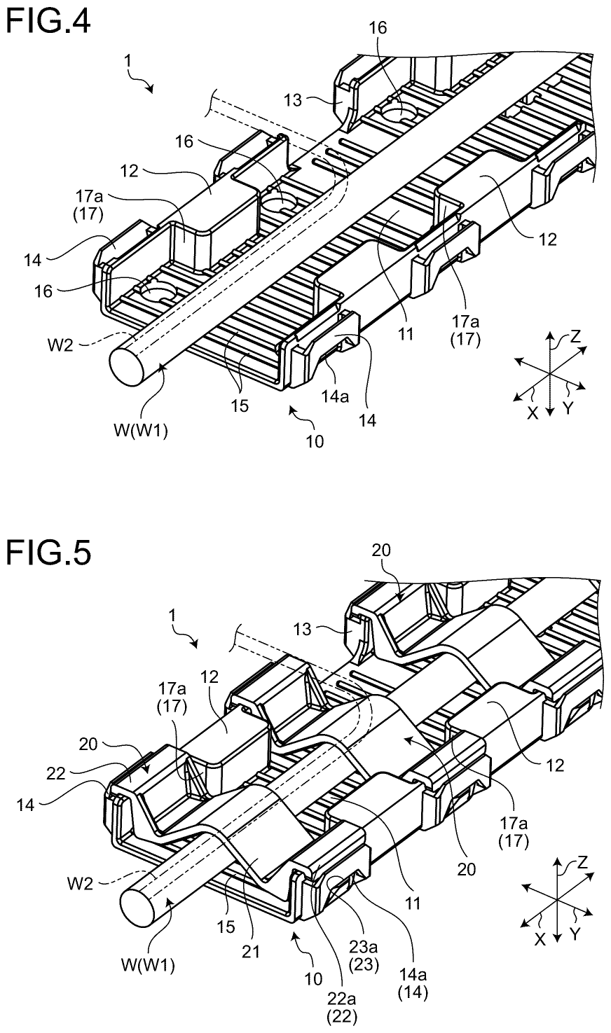

As illustrated in FIG. 1, the wire harness WH is configured to include, for example, a trunk line portion W1 extending along the axial direction X and a branch line portion W2 (see FIG. 4) branching from the trunk line portion W1. The trunk line portion W1 is a main portion of the wire harness WH, and is formed by bundling a plurality of electric wires W. For example, the trunk line portion W1 may include a portion where the largest number of electric wires W are bundled in the wire harness WH, or may include a portion having the largest outer diameter in the wire harness WH. In FIGS. 1 to 5, for the sake of convenience, the illustration of the plurality of electric wires W constituting the trunk line portion W1 is simplified.

The branch line portion W2 (see FIG. 4) is a sub harness portion of the wire harness WH, and is formed by a plurality of electric wires W branching from the trunk line portion W1. In the present embodiment, the wire harness WH is provided with a plurality of branch line portions W2 corresponding to a plurality of openings 13 (see FIG. 1), which will be described later, formed in the protector 1. The plurality of branch line portions W2 are bent along the width direction Y with respect to the trunk line portion W1 extending along the axial direction X, and are drawn out from the openings 13 to the outside of the protector 1 and routed. Note that in the present embodiment, three openings 13 are provided in the protector 1, but the number of openings 13 is not limited to this example, and for example, one, two, or four or more openings 13 may be provided.

For example, the plurality of electric wires W are formed to extend linearly along the axial direction X and extend with substantially the same diameter with respect to the axial direction X (extending direction). The electric wire W is configured to include a core wire and an insulating sheath covering the core wire. The electric wire W has, for example, the cross-sectional shape of the core wire (cross-sectional shape intersecting the axial direction X) formed in a substantially circular shape, and the cross-sectional shape of the insulating sheath formed in a substantially annular shape so as to be formed in a substantially circular cross-sectional shape as a whole. Note that in the present embodiment, the plurality of electric wires W are configured to have outer diameters equivalent to each other, but the present invention is not limited to this example, and for example, the electric wires W constituting the branch line portion W2 may be configured to have different outer diameters with respect to the plurality of electric wires W constituting the trunk line portion W1.

The protector 1 includes, for example, a base 10 and a plurality of covers 20. The plurality of covers 20 are formed of, for example, a flexible member having flexibility such as synthetic resin, and the base 10 is formed of, for example, a member harder than the cover 20 such as synthetic resin or metal. The plurality of covers 20 are provided at intervals along the axial direction X, and are assembled in a state of being stacked on one side in the height direction Z with respect to the base 10. The base 10 and the plurality of covers 20 are formed as separate bodies from each other, and are integrated with each other by a locking structure (snap fit) by a locking portion 23, which will be described later, in a state where the plurality of electric wires W are sandwiched therebetween. The protector 1 is configured in a flat shape thinned along the height direction Z as a whole by assembling the base 10 and the plurality of covers 20 to each other.

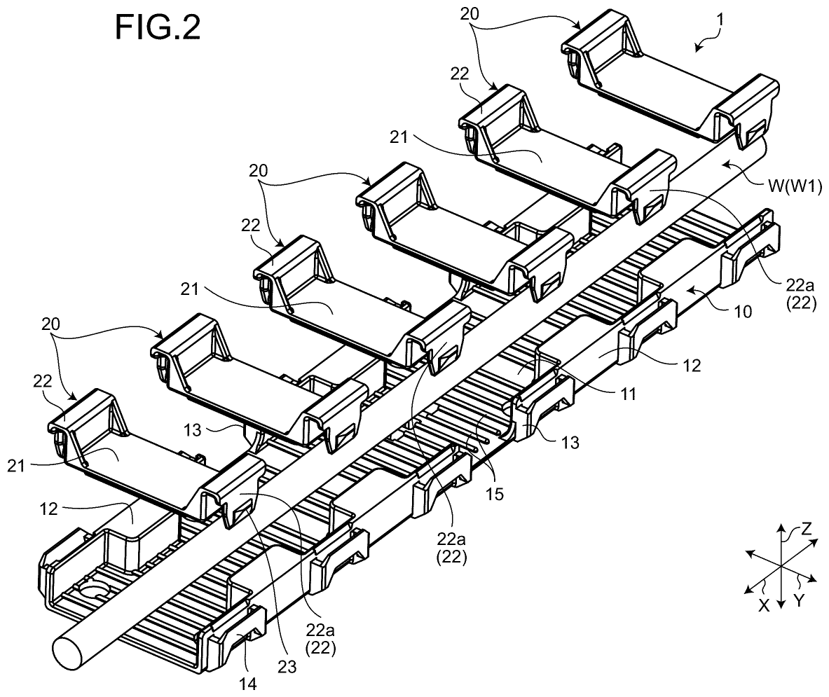

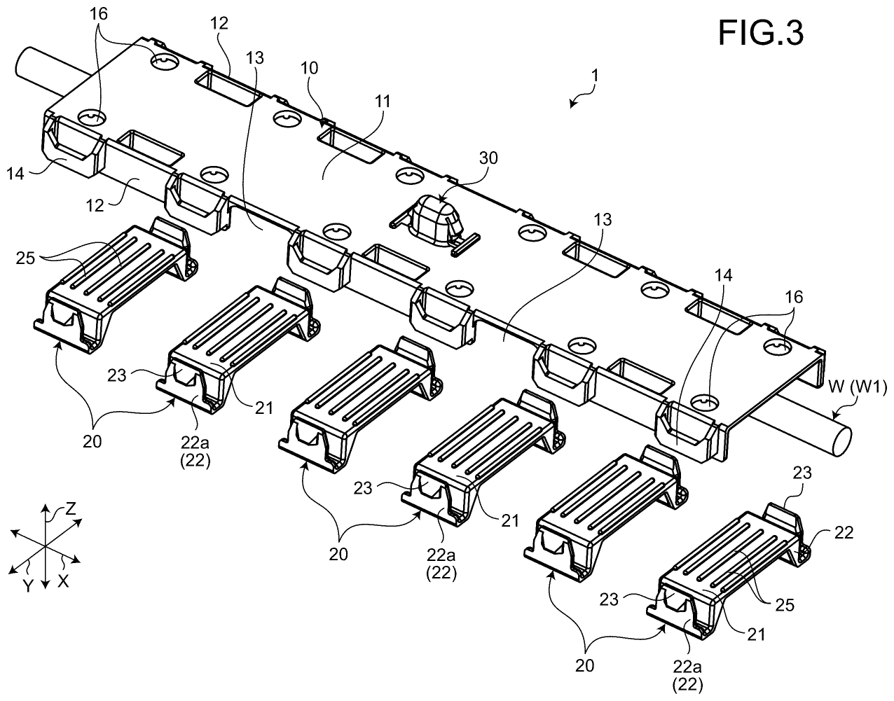

FIG. 2 is an exploded perspective view of the protector 1, and FIG. 3 is an exploded perspective view of the protector 1 as viewed from an angle different from that in FIG. 2. As illustrated in FIGS. 2 and 3, the base 10 includes, for example, a base-side bottom wall 11, a pair of base-side side walls 12, a plurality of openings 13, a plurality of locked portions 14, and a plurality of beads 15. The base-side bottom wall 11 and the pair of base-side side walls 12 are structures for partitioning the insertion space portion of the protector 1. The insertion space portion is a space portion through which the trunk line portions W1 of the plurality of electric wires W are inserted and routed along the axial direction X.

The base-side bottom wall 11 is formed in, for example, a flat plate shape and extends along the axial direction X. The base-side bottom wall 11 constitutes a lower end portion of the base 10. Furthermore, the base-side bottom wall 11 is formed integrally with the plurality of beads 15. The plurality of beads 15 project out from the base-side bottom wall 11 toward one side (the plurality of electric wires W side) in the height direction Z and extend along the width direction Y. The plurality of beads 15 are provided at intervals along the axial direction X, and function as anti-slips of the plurality of electric wires W, for example, by being arranged in a state of abutting on the plurality of electric wires W. Note that a clamp 30 (see FIG. 3) that fixes the protector 1 to a fixing target site of the vehicle is provided on a surface on a side opposite to the plurality of beads 15 of the base-side bottom wall 11.

The pair of base-side side walls 12, for example, projects out toward one side in the height direction Z from both end portions in the width direction Y of the base-side bottom wall 11 and extends along the axial direction X. The pair of base-side side walls 12 is configured including a base-side first side wall located on one side in the width direction Y and a base-side second side wall located on the other side in the width direction Y. The base-side first side wall constitutes a left end portion of the base 10, and the base-side second side wall constitutes a right end portion of the base 10.

The plurality of openings 13 are provided, for example, in each of the pair of base-side side walls 12. The plurality of openings 13 are through-holes penetrating the base-side first side walls or the base-side second side walls of the pair of base-side side walls 12 along the width direction Y, and are openings through which the above-described branch line portions W2 (see FIG. 4) are inserted. In the present embodiment, the base-side first side wall is provided with two openings 13 on both end portion sides in the axial direction X, and the base-side second side wall is provided with one opening 13 on the central portion side in the axial direction X. That is, the plurality of openings 13 are provided to be shifted from each other in the axial direction X.

The plurality of locked portions 14 are provided, for example, on outer surfaces of each of the pair of base-side side walls 12. In addition, the plurality of locked portions 14 are provided at intervals along the axial direction X, and are formed in, for example, a locking hole shape into which the plurality of locking portions 23 provided on the cover 20 side are inserted. Each locked portion 14 has a locked surface 14a (see FIG. 4) facing each locking portion 23 in the height direction Z, and the locked surface 14a and a locking surface 23a (see FIG. 5) of the locking portion 23 are locked in the height direction Z, whereby the cover 20 is locked with respect to the base 10.

The cover 20 is configured to include, for example, a cover-side bottom wall 21, a pair of cover-side side walls 22, a pair of locking portions 23, and a plurality of beads 25 (see FIG. 3). The cover-side bottom wall 21 and the pair of cover-side side walls 22 are structures for partitioning the insertion space portion of the protector 1. The insertion space portion is a space portion through which the trunk line portions W1 of the plurality of electric wires W are inserted and routed along the axial direction X. In the trunk line portion W1, for example, the plurality of electric wires W are exposed in a section between the plurality of covers 20 arranged side by side along the axial direction X.

The cover-side bottom wall 21 is formed in, for example, a flat plate shape and extends along the width direction Y. The cover-side bottom wall 21 constitutes a lower end portion of the cover 20. Furthermore, the cover-side bottom wall 21 is formed integrally with the plurality of beads 25. The plurality of beads 25 project out from the cover-side bottom wall 21 toward the other side (the plurality of electric wires W side) in the height direction Z and extend along the width direction Y. The plurality of beads 25 are provided at intervals along the axial direction X in each cover 20, and for example, function as anti-slip of the plurality of electric wires W by being arranged in a state of abutting on the plurality of electric wires W.

The pair of cover-side side walls 22, for example, project out toward one side in the height direction Z from both end portions in the width direction Y of the cover-side bottom wall 21. The pair of cover-side side walls 22 is configured to include a cover-side first side wall located on one side in the width direction Y and a cover-side second side wall located on the other side in the width direction Y. The cover-side first side wall constitutes a left end portion of the cover 20 and faces the base-side first side wall of the pair of base-side side walls 12 of the base 10. The cover-side second side wall constitutes a right end portion of the cover 20 and faces the base-side second side wall of the pair of base-side side walls 12 of the base 10.

In addition, the pair of cover-side side walls 22 has, for example, a distal end portion 22a disposed across the pair of base-side side walls 12. The distal end portion 22a extends in a substantially L-shape along the upper surface and the outer surface of the pair of base-side side walls 12. In other words, the pair of cover-side side walls 22 including the distal end portion 22a has a substantially U-shaped cross-section opened toward the other side in the height direction Z. The pair of cover-side side walls 22 is provided in a state where the distal end portion 22a is located on the outer surface side of the pair of base-side side walls 12 and the basal end portion is located on the inner surface side of the pair of base-side side walls 12.

The pair of locking portions 23 is provided, for example, on respective outer surfaces of the distal end portions 22a of the pair of cover-side side walls 22. The pair of locking portions 23 is formed in, for example, a claw shape to be inserted into the above-described plurality of locked portions 14 provided on the pair of base-side side walls 12. Each locking portion 23 has a locking surface 23a (see FIG. 5) facing each locked portion 14 in the height direction Z, and the locking surface 23a and the locked surface 14a of the locked portion 14 are locked in the height direction Z, whereby the cover 20 is locked with respect to the base 10.

FIG. 4 is a perspective view of the protector 1 in a state where the cover 20 is removed, and FIG. 5 is a perspective view of the protector 1 in a state where the cover 20 is attached. As illustrated in FIGS. 4 and 5, the base 10 is provided with a plurality of through-holes 16 penetrating the base-side bottom wall 11 along the height direction Z. The plurality of through-holes 16 are, for example, provided at intervals along the axial direction X at both end portions in the width direction Y of the base-side bottom wall 11. For example, a positioning pin or the like provided on a jig plate that supports the base 10 is inserted into the plurality of through-holes 16.

In the base 10, for example, the plurality of electric wires W are routed along the axial direction X in a state where the above-described positioning pins are inserted into the plurality of through-holes 16 and positioned with respect to the jig plate. The positioning pins projecting out from the plurality of through-holes 16 function as, for example, portions that suppress the trunk line portions W1 of the plurality of electric wires W from spreading in the width direction Y when the plurality of electric wires W are routed on the base-side bottom wall 11. In addition, for example, the positioning pin functions as a portion that forms a fold-back portion (curved portion) that bends the branch line portion W2 along the width direction Y when the branch line portion W2 branching from the trunk line portion W1 is drawn out from the opening 13.

Furthermore, the plurality of through-holes 16 are provided, for example, in the vicinity of the locked portion 14 at both end portions in the width direction Y of the base-side bottom wall 11. The locked portion 14 is a portion of the pair of base-side side walls 12 to which the cover 20 is attached. In the present embodiment, since the plurality of electric wires W are routed in a state where the spread of the trunk line portion W1 along the width direction Y is suppressed by the positioning pin described above, the plurality of electric wires W are suppressed from being sandwiched between the pair of cover-side side walls 22 and the base-side bottom wall 11 when the cover 20 is attached to the locked portion 14. Note that in the present embodiment, whether or not the plurality of covers 20 are attached to the base 10 can be detected for example, by arranging a sensor or the like in the plurality of through-holes 16 when the cover 20 is attached to the locked portion 14.

In addition, the base 10 is provided with, for example, a plurality of cutout portions 17 obtained by cutting out the pair of base-side side walls 12 along the width direction Y. The plurality of cutout portions 17 are, for example, provided at intervals along the axial direction X in each of the pair of base-side side walls 12. In the pair of base-side side walls 12, the thickness along the width direction Y of the portion provided with the cutout portion 17 in the axial direction X is thinned. The plurality of cutout portions 17 are provided, for example, in the vicinity of the locked portion 14 in the pair of base-side side walls 12, and function as groove portions with which the pair of cover-side side walls 22 of the cover 20 engages. The plurality of cutout portions 17 have side surfaces 17a facing the axial direction X, and the movement of the cover 20 in the axial direction X with respect to the base 10 is restricted by the abutment between the side surface 17a and the pair of cover-side side walls 22.

Here, in the present embodiment, the cover 20 is assembled to the base 10 so as to sandwich the plurality of electric wires W between the cover-side bottom wall 21 and the base-side bottom wall 11 in a state where the cover-side bottom wall 21 is elastically deformed along the outer shapes of the plurality of electric wires W. That is, in the present embodiment, in a state where the base 10 and the cover 20 are assembled, the cover-side bottom wall 21 is spaced apart along the height direction Z by the height of the plurality of electric wires W with respect to the base-side bottom wall 11, and is curved in a substantially U-shape opened toward the other side (the plurality of electric wires W side) in the height direction Z. As a result, an elastic restoring force is generated in the cover-side bottom wall 21, and the surface pressure between the cover-side bottom wall 21 and the plurality of electric wires W and the surface pressure between the base-side bottom wall 11 and the plurality of electric wires W are increased thus increasing the holding force of the plurality of electric wires W.

In the present embodiment, the locking portion 23 of the cover 20 described above is locked to the locked portion 14 of the base 10 in a state where elastic restoring force is generated in the cover-side bottom wall 21. In a state in which the locking surface 23a of the locking portion 23 and the locked surface 14a of the locked portion 14 are locked, the movement (coming-out) of the cover 20 to one side in the height direction Z with respect to the base 10 is restricted, and a state in which the surface pressure between the cover-side bottom wall 21 and the plurality of electric wires W and the surface pressure between the base-side bottom wall 11 and the plurality of electric wires W are increased is maintained.

In the present embodiment, for example, a plurality of covers 20 are sequentially assembled to the base 10 from one side to the other side in the axial direction X. In the plurality of covers 20, first, the locking portion 23 on one side in the width direction Y is locked to the locked portion 14 on one side in the width direction Y of the base 10. Next, the cover-side bottom wall 21 is elastically deformed (curved) along the outer shapes of the plurality of electric wires W, and in this state, the locking portion 23 on the other side in the width direction Y is locked to the locked portion 14 on the other side in the width direction Y of the base 10. Through such steps, the plurality of covers 20 can be assembled to the base 10.

In the present embodiment, the case where the pair of locking portions 23 is provided on both sides in the width direction Y of the cover 20 has been exemplified, but the present invention is not limited to this example, and for example, one side in the width direction Y of the cover 20 and one side in the width direction Y of the base 10 may be rotatably coupled via a hinge, and the locking portion 23 on the other side in the width direction Y of the cover 20 and the locked portion 14 on the other side in the width direction Y of the base 10 may be locked.

As described above, the protector 1 and the wire harness WH of the present embodiment include the base 10 having the base-side bottom wall 11 that supports the plurality of electric wires W extending along the axial direction X, and the cover 20 having the cover-side bottom wall 21 facing the base-side bottom wall 11 and sandwiching the plurality of electric wires W between the cover-side bottom wall 21 and the base-side bottom wall 11 in a state where the cover-side bottom wall 21 is elastically deformed along the outer shapes of the plurality of electric wires W. With this configuration, for example, the protector 1 and the wire harness WH can hold the plurality of electric wires W by sandwiching the plurality of electric wires W between the cover-side bottom wall 21 and the base-side bottom wall 11 in a state where the cover-side bottom wall 21 is elastically deformed along the outer shapes of the plurality of electric wires W. As a result, the protector 1 and the wire harness WH can improve the holding force of the plurality of electric wires W, and furthermore, the base 10 and the cover 20 can be configured to be thinner along the height direction Z.

Moreover, in the protector 1 and the wire harness WH of the present embodiment, the base 10 is provided with a plurality of covers 20 at intervals along the axial direction X. With this configuration, the protector 1 and the wire harness WH, for example, can fix the electric wires W at a plurality of locations in the axial direction X in the base 10 by the plurality of covers 20, and furthermore, further improve the holding force of the plurality of electric wires W.

In addition, in the protector 1 and the wire harness WH of the present embodiment, the base 10 has a pair of base-side side walls 12 provided at both end portions in the width direction Y of the base-side bottom wall 11, and the pair of base-side side walls 12 is provided with the opening 13 through which the branch line portion W2 branching from the trunk line portion W1 extending along the axial direction X among the plurality of electric wires W is inserted. With this configuration, the protector 1 and the wire harness WH can, for example, draw out and route the branch line portion W2 branching from the trunk line portion W1 of the plurality of electric wires W to the outside of the base 10 by the opening 13.

In the protector 1 and the wire harness WH of the present embodiment, the cover 20 includes the pair of cover-side side walls 22 provided at both end portions in the width direction Y of the cover-side bottom wall 21, and the pair of locking portions 23 provided at the distal end portions 22a of the pair of cover-side side walls 22 and locked to the pair of base-side side walls 12 in a state where the cover-side bottom wall 21 is elastically deformed. With this configuration, the protector 1 and the wire harness WH can hold (maintain) a state in which the cover-side bottom wall 21 is elastically deformed by the pair of locking portions 23, for example, and can further improve the holding force of the plurality of electric wires W.

In addition, in the protector 1 and the wire harness WH of the present embodiment, the base-side bottom wall 11 and the cover-side bottom wall 21 each includes a plurality of beads 15 and 25 that are extended along the width direction Y, provided at intervals along the axial direction X, and abutted on the plurality of electric wires W. With this configuration, in the protector 1 and the wire harness WH, for example, the plurality of beads 15 and 25 function as anti-slips of the plurality of electric wires W, and furthermore, can suppress relative movement of the plurality of electric wires W in the axial direction X with respect to the base 10 and the cover 20.

Note that in the present embodiment, the case where the plurality of beads 15 and 25 are provided on the base-side bottom wall 11 and the cover-side bottom wall 21, respectively, has been exemplified, but the present invention is not limited to this example, and for example, the plurality of beads 15 or the plurality of beads 25 may be provided on only one of the base-side bottom wall 11 and the cover-side bottom wall 21. In the present embodiment, the case where the opening 13 through which the branch line portion W2 is inserted is provided in each of the pair of base-side side walls 12 has been exemplified, but the present invention is not limited to this example, and for example, the opening 13 through which the branch line portion W2 is inserted may be provided in only one of the pair of base-side side walls 12.

Although the embodiments of the present invention have been exemplified above, the above embodiments are merely examples, and are not intended to limit the scope of the invention. The above-described embodiments can be implemented in various other forms, and various omissions, substitutions, combinations, and changes can be made within a scope not deviating from the gist of the invention. In addition, specifications (structure, type, direction, form, size, length, width, thickness, height, number, arrangement, position, material, etc.) of each configuration, shape, and the like can be appropriately changed and implemented.

In a protector and a wire harness according to the present embodiment, a plurality of electric wires can be held by sandwiching the plurality of electric wires between a cover-side bottom wall and a base-side bottom wall in a state where the cover-side bottom wall is elastically deformed along the outer shapes of the plurality of electric wires. As a result, an effect that the protector and the wire harness can improve the holding force of the plurality of electric wires is obtained.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A protector comprising:
a base having a base-side bottom wall that supports a plurality of electric wires extending along an axial direction; and
a cover having a cover-side bottom wall facing the base-side bottom wall, the plurality of electric wires being sandwiched between the cover-side bottom wall and the base-side bottom wall in a state where the cover-side bottom wall is elastically deformed along outer shapes of the plurality of electric wires.

2. The protector according to claim 1, wherein
the base is provided with a plurality of the covers at intervals along the axial direction.

3. The protector according to claim 1, wherein
the base includes a pair of base-side side walls provided at both end portions in a width direction intersecting the axial direction of the base-side bottom wall, and
at least one of the pair of base-side side walls is provided with an opening through which a branch line portion branching from a trunk line portion extending along the axial direction among the plurality of electric wires is inserted.

4. The protector according to claim 2, wherein
the base includes a pair of base-side side walls provided at both end portions in a width direction intersecting the axial direction of the base-side bottom wall, and
at least one of the pair of base-side side walls is provided with an opening through which a branch line portion branching from a trunk line portion extending along the axial direction among the plurality of electric wires is inserted.

5. The protector according to claim 3, wherein
the cover includes a pair of cover-side side walls provided at both end portions of the cover-side bottom wall in the width direction, and a pair of locking portions provided at distal end portions of the pair of cover-side side walls and locked to the pair of base-side side walls in a state where the cover-side bottom wall is elastically deformed.

6. The protector according to claim 4, wherein
the cover includes a pair of cover-side side walls provided at both end portions of the cover-side bottom wall in the width direction, and a pair of locking portions provided at distal end portions of the pair of cover-side side walls and locked to the pair of base-side side walls in a state where the cover-side bottom wall is elastically deformed.

7. The protector according to claim 1, wherein
at least one of the base-side bottom wall and the cover-side bottom wall includes a plurality of beads that are extended along a width direction intersecting the axial direction, provided at intervals along the axial direction, and abutted on the plurality of electric wires.

8. The protector according to claim 2, wherein
at least one of the base-side bottom wall and the cover-side bottom wall includes a plurality of beads that are extended along a width direction intersecting the axial direction, provided at intervals along the axial direction, and abutted on the plurality of electric wires.

9. A wire harness comprising:
a plurality of electric wires extending along an axial direction; and
a protector that holds the plurality of electric wires, wherein
the protector includes:
a base having a base-side bottom wall that supports the plurality of electric wires; and
a cover having a cover-side bottom wall facing the base-side bottom wall, the plurality of electric wires being sandwiched between the cover-side bottom wall and the base-side bottom wall in a state where the cover-side bottom wall is elastically deformed along outer shapes of the plurality of electric wires.
